(19) United States
(12) Patent Application Publication
(10) Pub. No.: US 2023/0103575 A1
(43) Pub. Date: Apr. 6, 2023

(54) IN-CONTEXT VISUAL SEARCH

(71) Applicant: Microsoft Technology Licensing, LLC, Redmond, WA (US)

(72) Inventors: Nicholas Fredrick RAY, Seattle, WA (US); Adam Jeffrey CURTIS, Seattle, WA (US); Jeffrey Roger DEVRIES, Seattle, WA (US); Cheyenne ISMAILCIUC, Cupertino, CA (US); Niveah Tefillah ABRAHAM, North Bend, WA (US); Nektarios IOANNIDES, Seattle, WA (US); Arun SACHETI, Sammamish, WA (US); Avinash VEMULURU, Sammamish, WA (US)

(21) Appl. No.: 17/556,995

(22) Filed: Dec. 20, 2021

Related U.S. Application Data
(60) Provisional application No. 63/252,442, filed on Oct. 5, 2021.

(51) Int. Cl. G06F 16/957; G06F 16/532; G06F 3/0482

(52) U.S. Cl. CPC G06F 16/9577; G06F 16/532; G06F 3/0482; G06F 2203/04803

(57) ABSTRACT

The present disclosure relates to systems and methods for providing a visual search within a browser. The systems and methods allow users to trigger a visual search from the browser within the user's browsing context. The users may trigger a visual search by hovering over an image and selecting a visual search icon or selecting a visual search option within a context menu. Selecting the visual searches may cause a sidebar to open with visual search results or a flyout to display with visual search results.

### CROSS-REFERENCE TO RELATED APPLICATIONS

This application claims priority to and the benefit of U.S. Provisional Patent Application No. 63/252,442, filed on Oct. 5, 2021, which is hereby incorporated by reference in its entirety.

### BACKGROUND

Visual search is an emerging technology that lets users search using an image, identifying objects, landmarks, places, and things in the image; and find similar content to the identified objects, landmarks, places, and things in the image. Most traditional visual search experiences require straying out of browsing context (e.g., in new tab, opening a new module, using a specialized program or website) to view the visual search results. Traditional visual search experiences also typically require users to upload the images into the browser to perform the visual search.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One example implementation relates to a method for performing visual searching. The method may include presenting a webpage including an image. The method may include presenting a context menu with a visual search option in response to receiving a user selection of the image. The method may include sending a visual search request for the image in response to receiving a selection of the visual search option. The method may include receiving visual search results based on a visual search of the image. The method may include while continuing to present the webpage, presenting the visual search results.

Another example implementation relates to a method for performing visual searching. The method may include presenting a webpage including an image. The method may include presenting a visual search icon on the image. The method may include sending a visual search request for a visual search of the image in response to receiving a selection of the visual search icon. The method may include while continuing to present the webpage, presenting received visual search results for the image.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 illustrates an example environment for performing visual searches in accordance with implementations of the present disclosure.

FIG. 2 illustrates an example graphical user interface (GUI) of a browser with a webpage with a context menu presented nearby an image and a sidebar with visual search results for the image in accordance with implementations of the present disclosure.

FIG. 3 illustrates an example GUI of a browser with a webpage with a visual search image icon presented nearby an image and a sidebar with visual search results in accordance with implementations of the present disclosure.

FIG. 4A illustrates an example webpage with a hover occurring on an image in accordance with implementations of the present disclosure.

FIG. 4B illustrates an example webpage with a visual search icon presented on the image where the hover occurred in accordance with implementations of the present disclosure.

FIG. 5A illustrates an example GUI of a webpage with a visual search icon presented next to an image in accordance with implementations of the present disclosure.

FIG. 5B illustrates an example GUI of a webpage with an expanded visual search icon presented next to an image in accordance with implementations of the present disclosure.

FIG. 5C illustrates an example GUI of a webpage with a flyout presented next to an image in accordance with implementations of the present disclosure.

FIG. 6A illustrates an example GUI of a webpage with an icon to save the image or the visual search results to a collection in accordance with implementations of the present disclosure.

FIG. 6B illustrates an example GUI of a webpage with a popup window displaying different collections in accordance with implementations of the present disclosure.

FIG. 6C illustrates an example GUI of a webpage with a flyout with the visual search results presented adjacent to an image in accordance with implementations of the present disclosure.

FIG. 7 illustrates an example GUI of a webpage with a context menu and a flyout with the visual search results presented next to an image on the webpage in accordance with implementations of the present disclosure.

FIG. 8 illustrates an example GUI of a webpage with a visual search icon placed on an image below another icon on the image in accordance with implementations of the present disclosure.

FIG. 9 illustrates an example GUI of a flyout in accordance with implementation of the present disclosure.

FIG. 10 illustrates an example GUI of a flyout in accordance with implementations of the present disclosure.

FIG. 11 illustrates an example method for performing visual searching in accordance with implementations of the present disclosure.

FIG. 12 illustrates an example method for performing visual searching in accordance with implementations of the present disclosure.

FIG. 13 illustrates an example method for performing visual searching in accordance with implementations of the present disclosure.

FIG. 14 an example method for performing visual searching in accordance with implementations of the present disclosure.

### DETAILED DESCRIPTION

This disclosure generally relates to visual search. Visual searching allows users to search using an image by identifying objects, landmarks, places, and things in the image; and find similar content to the identified objects, landmarks, places, and things in the image. Most traditional visual search experiences require straying out of browsing context (e.g., in new tab, opening a new module, using a specialized program or website) to view the visual search results. Traditional visual search experiences also generally require users to upload the images into the browser to perform the visual search. For example, traditionally when user uses a browser on a device to access webpages that provide images of individuals and/or products. The user may see a product the user likes in the images and may try to search for the product using a traditional visual search experience (e.g., search the web for image) to identify the product. The user may open a new tab and move to another webpage for the visual search, which the user may find annoying or difficult. In addition, the user may be unable to locate where to purchase the products or learn more about the products with the traditional visual search experiences.

The present disclosure provides a visual search within a browser. The present disclosure allows users to trigger a visual search within the user's browsing context. The present disclosure allows users to discover related content for any images or videos in a browser search result page by requesting a visual search for the images or videos. Visual searching may be used in shopping and/or exploration of ideas or content. The visual search results may show on any webpage accessed through the browser through a flyout or popup window displayed on the webpage. The visual search results may also display in a sidebar presented nearby, or adjacent to, any webpage accessed through the browser. In some implementations, the visual search uses context information from the webpage to inform the visual search. In some circumstances, the visual search advantageously uses additional context information from the webpage to inform the visual search. One example of context information from the webpage includes using the page title that the image appears on as additional input. Other examples of context information from the webpage include using the text around the image, other images on the webpage, and/or entities on the page.

A trigger for visual searches may include on-hover (e.g., the user hovers over an image). Images viewed in the browser may have a visual search icon overlaid the images in response to detecting a hover by the user over the image. Selecting the visual search icon by the users may send a visual search request for the image and cause a sidebar to open with visual search results or a popup window to display with visual search results.

Another trigger for visual searches may include the context menu of the browser (e.g., the context menu includes a visual search option). Selecting the visual search option in the context menu by the users may send a visual search request for the image and cause a sidebar to open with visual search results or a popup window to display with visual search results.

The visual search results may include actions the users may take. For example, if the Eiffel Tower is identified in the image, the visual search results may include buttons with different labels (e.g., history, hours, directions, find other images, etc.) that the user may select to learn about the Eiffel Tower. Another example includes the visual search results for a product including icons the user may select for purchase and price comparison actions. As such, the visual search may be the start of a deeper engagement funnel, by aiding in scenario-specific task completion for the users (e.g., providing actions the user may take), rather than just surfacing the visual search results.

One example use case includes a user using a browser on a device to access webpages that provide images of individuals and/or products. The user may see a product the user likes in the images. The user may use the present disclosure to perform a visual search of the image by selecting a visual search icon on the image with the product. The visual search results are displayed next to the image in a flyout with the product names, prices for the product, and retailers that have the product in stock. Thus, the information for the product (product names, prices, retailers, etc.) is available in the browsing context without ever having to leave the webpage with the images of the individuals and/or products. As such, the user may shop and explore the products in the images without ever leaving the webpage.

One technical advantage of some implementations of the present disclosure is allowing users to seamlessly discover visual search results while remaining in-context of the browser. Remaining in-context of the browser saves users from needing to save the images to the device and upload the saved images to the browser for the visual search. As such, users may perform quick searches of the images while staying in-context of the browser, and thus, the present disclosure encourages visual searches without disrupting the core experience of the users browsing. Another technical advantage of some implementations of the present disclosure is increased browser search functionality by leveraging browser distribution alongside visual search.

The present disclosure also provides a convenient visual search experience to allow visual searching without disrupting the browsing task at hand. As such, the present disclosure increases user engagement with the browser by incorporating visual search into the browser context.

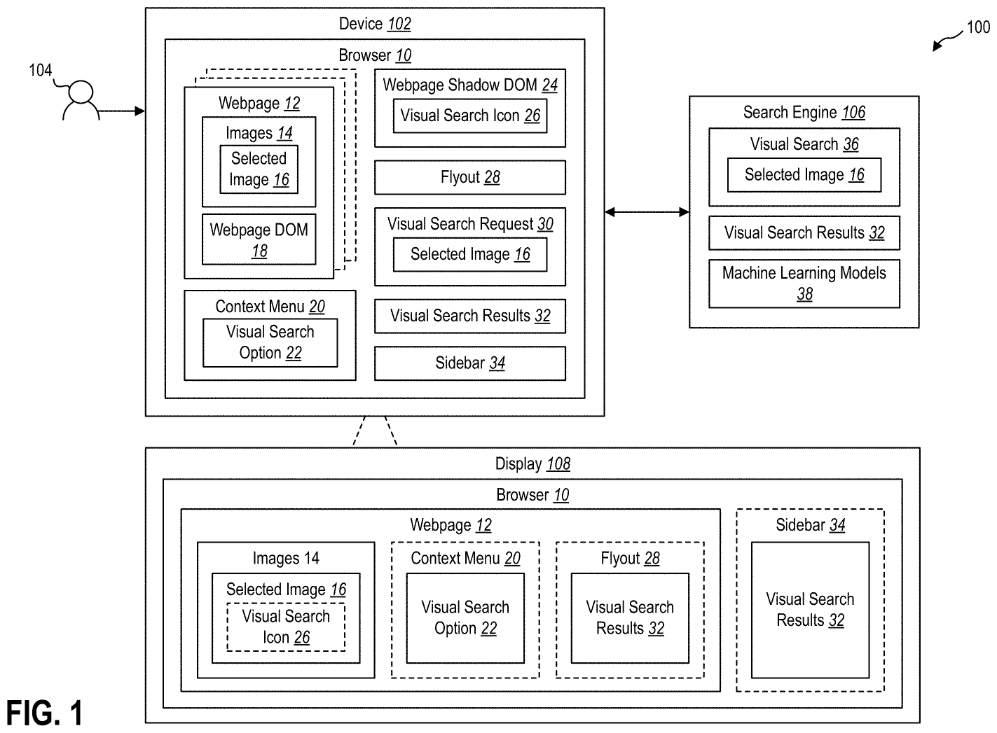

Referring now to FIG. 1, illustrated is an example environment 100 for performing visual searches. The environment 100 may include one or more users 104 interacting with one or more devices 102. The devices 102 may include one or more browsers 10 that allow the users 104 to interact with information on the World Wide Web. When a user 104 requests a webpage 12 from a website (e.g., by performing a search using the browser 10 or entering in a uniform resource locator (URL) of a website using the browser 10), the browser 10 retrieves the content of the webpage 12 from a webserver and displays the webpage 12 on a display 108 of the user's device 102. The webpage 12 may be any webpage (third party webpages or webpages from the same party that provides the browser 10). In addition, the browser 10 may be a browser application on a device 102 of the user 104. Examples of browsers 10 include, but are not limited to, EDGE™ and INTERNET EXPLORER™. Browser data may be generated from users 104 worldwide based on the interactions of the users 104 with the browser 10.

The browser 10 may present webpages 12 with one or more images 14 and/or videos. The user 104 may select one image 16 or video of the plurality of images 14 presented on the webpage 12 for a visual search 36. Selecting the image 16 includes clicking on the image 16 (e.g., right-clicking), hovering over the image 16, and/or tabbing through the page elements until the image 16 is the active element. A visual search 36 performs a search using an image or video as input, and the results of the visual search 36 may be any type of search engine results, including, but not limited to, identification and related content. One example of the user 104 selecting the image 16 is the user 104 right clicking on the image 16. The browser 10 may present a context menu 20 with a visual search option 22 in response to the user 104 right clicking on the selected image 16. If the user selects the visual search option 22, a visual search request 30 for the selected image 16 may be sent to a search engine 106 in communication with the device 102.

Another example of the user 104 selecting the image 16 is the user 104 hovering over the image 16. For example, the browser 10 may detect a hover when the user 104 positions a pointer, a mouse cursor, or a stylus on the image 16 for a time period (e.g., one second or two seconds). The browser 10 may display a visual search icon 26 on the selected image 16 in response to detecting the user 104 hovering over the image 16. If a plurality of images 14 are displayed on the webpage 12, the visual search icon 26 may only appear on the selected image 16.

The browser 10 may perform an initial verification to determine whether to trigger displaying the visual search icon 26 on the selected image 16. The browser 10 may compare an image size of the selected image 16 to a threshold. If the image size is equal to or greater than the threshold, the browser 10 may present the visual search icon 26 on the selected image 16. If the image size is less than the threshold, the browser 10 may forego presenting the visual search icon 26. The threshold may be a minimum image size. One example of a minimum image size is 90 pixel by 90 pixel. In addition, the threshold may be a ratio of the image size to a size of the visual search icon (e.g., a six to one ratio where the image size is at least six times larger than the size of the visual search icon).

The initial verification may also include determining whether the selected image 16 is a dominant image. A dominant image may be related to the context of the webpage 12. If the selected image 16 is a dominant image, the browser 10 may present the visual search icon 26 on the selected image 16, and if the selected image 16 is not a dominant image, the browser 10 may forego presenting the visual search icon 26 on the selected image 16. The browser 10 may use the position of the selected image 16 on the webpage 12 in determining whether the selected image 16 is a dominant image. For example, if the image is in a banner at the top of the webpage 12, the browser 10 may determine that the image is an advertisement or a company logo and is unrelated to the content of the webpage 12 and not a dominant image. If the selected image 16 is near the center of the webpage 12, the browser 10 may determine that the selected image 16 is related to the content of the webpage 12 and is a dominant image.

The browser 10 may also use the source of the selected image 16 in determining whether the selected image 16 is a dominant image. For example, images for advertisements or logos may be determined to be unrelated to the context of the webpage 12, and thus, the browser may determine that the images are not a dominant image. The browser 10 may use one or more machine learning models in determining whether the selected image is a dominant image. As such, the browser 10 may verify that the selected image 16 is large enough to display the visual search icon 26 in combination with verifying that the selected image 16 is a dominant image.

If the browser 10 determines to trigger the display of the visual search icon 26 on the selected image 16, the browser 10 may also determine a position to display the visual search icon 26 on the selected image 16. The position of the visual search icon 26 may be selected to prevent occlusion of objects, items, or individuals in the selected image 16 or prevent interference with another icon or click event on the selected image 16. Click events include icons, buttons, or activatable portions in the selected image 16. For example, the browser 10 displays the visual search icon 26 on the edges or corners of the selected image 16. Another example includes the browser 10 displaying the visual search icon 26 near another click event or icon on the selected image 16. For example, if the selected image 16 includes a heart icon, the browser 10 may position the visual search icon 26 below the heart icon. The browser 10 may automatically determine the position of the visual search icon 26 using hit testing. The hit testing may determine whether the visual search icon 26 is receiving click events and/or whether occlusion is occurring with the visual search icon 26. If the visual search icon 26 is not receiving click events or if occlusion is occurring, the browser 10 may move the visual search icon 26 to a different position.

The browser 10 may display the visual search icon 26 using a webpage shadow document object model (DOM) 24. The webpage shadow DOM 24 may operate in conjunction with the webpage DOM 18. The webpage DOM 18 provides the structure and the content of the webpage 12, and the webpage shadow DOM 24 is a separate layer provided by the browser 10 that can operate on the webpage 12. The visual search icon 26 may be separate from the webpage DOM 18 preventing the visual search icon 26 from interfering with or changing the existing web experience of the webpage 12. The webpage shadow DOM 24 may be provided as a browser feature for the browser 10. Thus, any webpage 12 presented on the browser 10 may use the webpage shadow DOM 24. The browser 10 may also add the visual search icon 26 as part of the browser application on the device 102, and thus, any webpage 12 presented on the browser 10 may use the visual search icon 26.

If the user selects the visual search icon 26, a visual search request 30 for the selected image 16 may be sent to a search engine 106 in communication with the device 102. The search engine 106 may perform a visual search 36 of the selected image 16 by identifying objects in the selected image 16 and/or recognize individuals, landmarks, places, and/or things in the selected image 16 and searching the World Wide Web to find similar content to the identified individuals, objects, landmarks, places, and/or things in the selected image 16.

One example of a visual search 36 includes searching for similar images as the selected image 16 across the World Wide Web. Another example of a visual search 36 includes identifying the name of an individual in the selected image 16 or finding other images of the individual across the World Wide Web. Another example of a visual search 36 includes exploring what is nearby a landmark identified in the selected image 16. Another example of a visual search 36 includes identifying a type of animal in the selected image 16 or other images of animals similar to the animal identified in the selected image 16. Another example of a visual search 36 includes identifying related products to a product identified in the selected image 16. Another example of a visual search 36 includes identifying similar items to a product identified in the selected image 16. Another example of a visual search 36 includes identifying a type of plant identified in the selected image 16. Another example of a visual search 36 includes identifying text in the selected image 16 and performing a search based on the text.

The visual search results 32 include the similar content identified during the visual search 36. For example, the visual search results 32 include similar images, related images, product images, shopping options, and/or related searches based on the selected image 16. Related searches may include textual searches or other visual searches. Another example of the visual search results 32 include identifying a landmark in the selected image 16 and providing a link or icon to select for planning a trip to the city where the landmark is located. Another example of the visual search results 32 include related recipes to food identified in the selected image 16. Another example of the visual search results 32 include related tools for a tool identified in the selected image 16.

The visual search results 32 may also include results for a plurality of items, objects, individuals, and/or products identified in the selected image 16. For example, if the search engine 106 identified a landmark and a famous individual in the selected image 16, the visual search results 32 may include information for the identified landmark and information about the famous individual. The visual search results 32 may be placed in an order or grouped based on, for example, text, the entity identified, related products, and/or related content. The browser 10 may use one or more machine learning models to determine an order or group of the visual search results 32. For example, if the selected image 16 is of a product, the machine learning models may identify the product images in the visual search results 32 and place the product images higher in the visual search results 32 relative to images of other objects or items. As such, the visual search results 32 may be specific to the selected image 16.

In an implementation, the search engine 106 uses one or more machine learning models 38 to identify the individuals, objects, landmarks, places, things, etc. in the selected image 16 and/or determine the visual search results 32 (e.g., the similar content). The search engine 106 provides the visual search results 32 to the device 102 for the selected image 16.

The browser 10 displays the received visual search results 32. The browser 10 may display the visual search results 32 in a flyout 28 nearby or adjacent to the images 14 (e.g., next to the selected image 16, above the selected image 16, below the selected image 16, or at an angle from the selected image 16). The flyout 28 may be an overlay or a popup window on the webpage 12. In addition, the flyout 28 may be visually distinct from the webpage 12 (e.g., have a border or otherwise offset the visual search results 32 from the images 14 or other content on the webpage 12).

The browser 10 may determine a position of the flyout 28 based on a position of the selected image 16 on a screen of the display 108. For example, if the selected image 16 is displayed in a lower portion of the screen (e.g., the bottom half of the screen), the flyout 28 may be positioned higher on the screen, and if the selected image 16 is displayed in a higher position of the screen (e.g., the top half of the screen), the flyout 28 may be positioned lower on the screen. As such, the browser 10 may adjust a position of the flyout 28 to ensure that the flyout 28 is visible to the user 104.

In addition, the browser 10 determines an appropriate size of the flyout 28. The size of the flyout 28 may be based on available screen space. The size of the flyout 28 may also be based on display characteristics or device specifications. Thus, the size of the flyout 28 may change for different devices 102 or displays 108. The browser 10 may also determine when to automatically dismiss or close the flyout 28. For example, if the user 104 selects a different image on the webpage 12 or moves a pointer or a mouse cursor to a different location on the webpage 12, the browser 10 may automatically dismiss or close the flyout 28.

The browser 10 may add the flyout 28 as part of the browser application on the device 102. As such, the flyout 28 may be separate from the webpage DOM 18 preventing the flyout 28 from interfering with or changing the existing web experience of the webpage 12. Moreover, any of the webpages 12 displayed using the browser 10 may use the flyout 28.

By displaying the visual search results 32 in a flyout 28 within the webpage 12, the visual search results 32 are presented within the context of the user's 104 current browsing experience, and thus, the user 104 may interact with the visual search results 32 without opening a new tab within the browser 10.

The browser 10 may also display the visual search results 32 in a sidebar 34 nearby, or adjacent to, the webpage 12. The sidebar 34 may be in a right pane of the browser 10. For example, the browser 10 presents the webpage 12 on the left portion of the screen and the sidebar 34 on the right portion of the screen. The sidebar 34 is a separate window from the webpage 12 and the size of the sidebar 34 may be based on a pixel value or a percentage of a display size. As such, the sidebar 34 is displayed by the browser 10 in the context of the user's 104 browsing experience, allowing the user 104 to view the visual search results 32 without opening a new tab or leaving the webpage 12.

The environment 100 may have multiple machine learning models (e.g., machine learning models 38) running simultaneously. In some implementations, one or more computing devices (e.g., search engines 106, and/or devices 102) are used to perform the processing of environment 100. The one or more computing devices may include, but are not limited to, server devices, personal computers, a mobile device, such as, a mobile telephone, a smartphone, a PDA, a tablet, or a laptop, and/or a non-mobile device. The features and functionalities discussed herein in connection with the various systems may be implemented on one computing device or across multiple computing devices. For example, the browser 10 and the search engine 106 are implemented wholly on the same computing device. Another example includes one or more subcomponents of the search engine 106 implemented across multiple computing devices. Moreover, in some implementations, the search engine 106 are implemented or processed on different server devices of the same or different cloud computing networks. Moreover, in some implementations, the features and functionalities are implemented or processed on different server devices of the same or different cloud computing networks.

In some implementations, each of the components of the environment 100 is in communication with each other using any suitable communication technologies. In addition, while the components of the environment 100 are shown to be separate, any of the components or subcomponents may be combined into fewer components, such as into a single component, or divided into more components as may serve a particular embodiment. In some implementations, the components of the environment 100 include hardware, software, or both. For example, the components of the environment 100 may include one or more instructions stored on a computer-readable storage medium and executable by processors of one or more computing devices. When executed by the one or more processors, the computer-executable instructions of one or more computing devices can perform one or more methods described herein. In some implementations, the components of the environment 100 include hardware, such as a special purpose processing device to perform a certain function or group of functions. In some implementations, the components of the environment 100 include a combination of computer-executable instructions and hardware.

As such, the environment 100 allows users 104 to seamlessly discover visual search results 32 while remaining in-context of the browser 10. Moreover, the environment 100 allows users 104 to interact with visual search results 32 with minimal effort by allowing the users 104 to view the visual search results 32 without leaving the browsing context by opening a new tab with the visual search results 32.

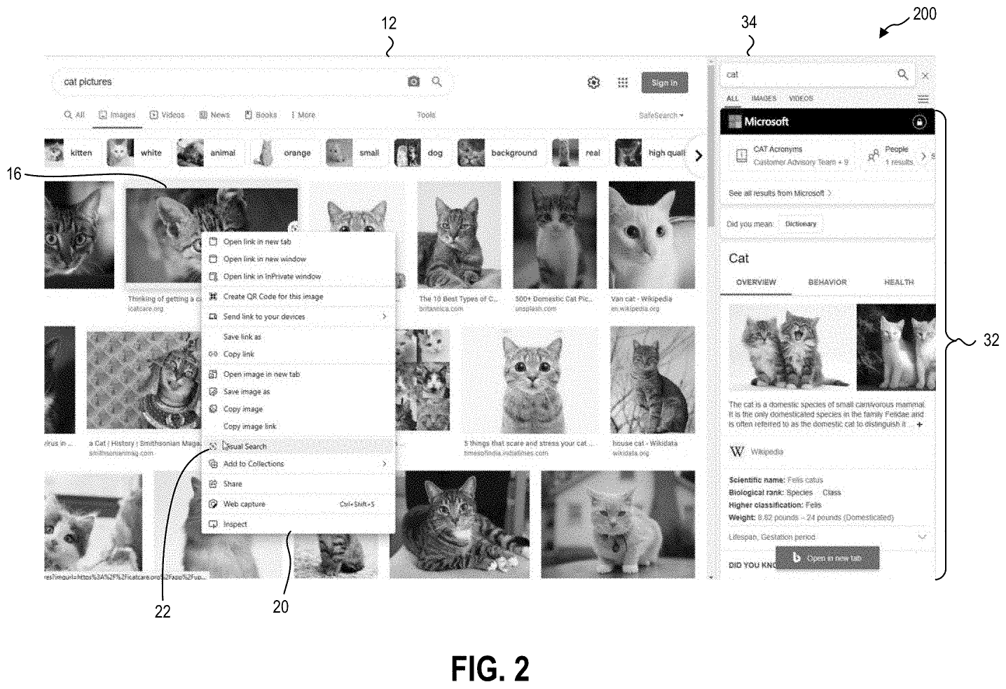

Referring now to FIG. 2, illustrated is an example graphical user interface (GUI) 200 of a webpage 12 and a sidebar 34 displayed within a browser 10 (FIG. 1). The user 104 is using the webpage 12 to perform a search for cat pictures. The webpage 12 presents a plurality of images with cats in response to the query “cat pictures.” The user 104 may select an image 16 of the plurality of images and may right-click on the selected image 16. The webpage 12 presents a context menu 20 that includes a visual search option 22 displayed over the selected image 16 of a cat. The browser 10 presents the context menu 20 in response to receiving a right-click by the user 104 on the selected image 16.

The GUI 200 also includes a sidebar 34 with the received visual search results 32 presented within the browser 10. The visual search results 32 include related searches of cats and related content to cats. The sidebar 34 is displayed next to the webpage 12, for example, in a right frame of the browser 10. As such, the sidebar 34 presents the visual search results 32 next to the webpage 12 with the selected image 16 so that the user 104 may view the visual search results 32 within the same browsing context of the webpage 12.

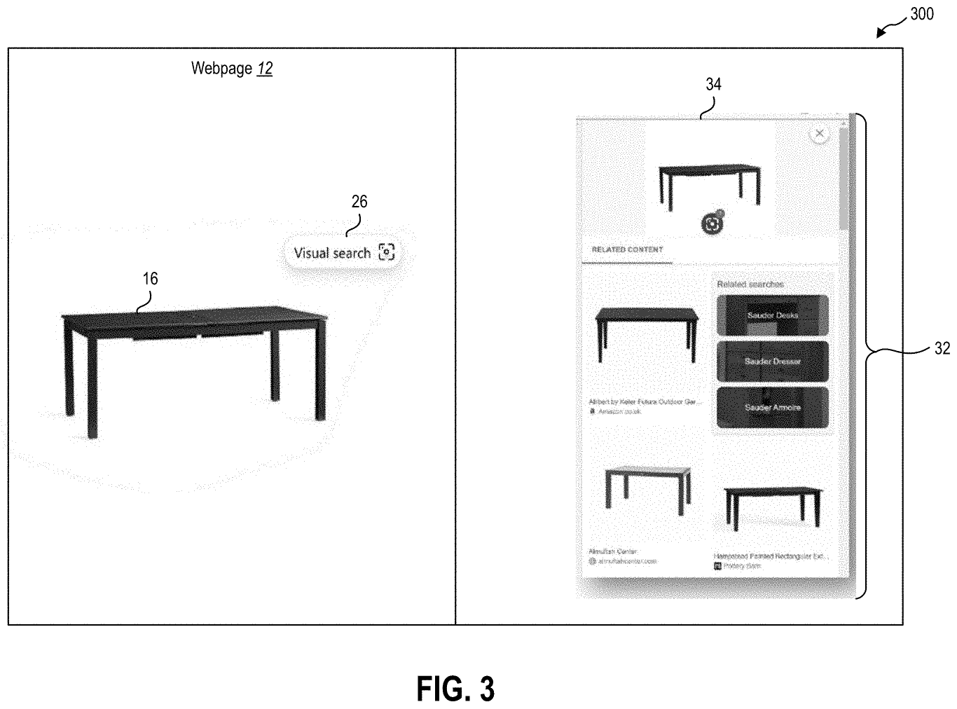

Referring now to FIG. 3, illustrated is an example GUI 300 of a webpage 12 and a sidebar 34 displayed within a browser 10 (FIG. 1). The webpage 12 includes a selected image 16 of a table. The selected image 16 includes a visual search icon 26 presented nearby the selected image 16. For example, the browser 10 may detect a hover over the selected image 16 (e.g., the user 104 positions a mouse cursor over the selected image 16 for half a second) and the browser 10 displays a visual search icon 26 on the webpage 12 in response to detecting the hover occurring over the selected image 16.

The GUI 300 also includes a sidebar 34 with the received visual search results 32 presented adjacent to the webpage 12 within the browser 10. When the user 104 selects the visual search icon 26, the browser 10 sends a visual search request 30 for the selected image 16 to the search engine 106 and the browser 10 displays the received visual search results 32 from the search engine 106 in the sidebar 34.

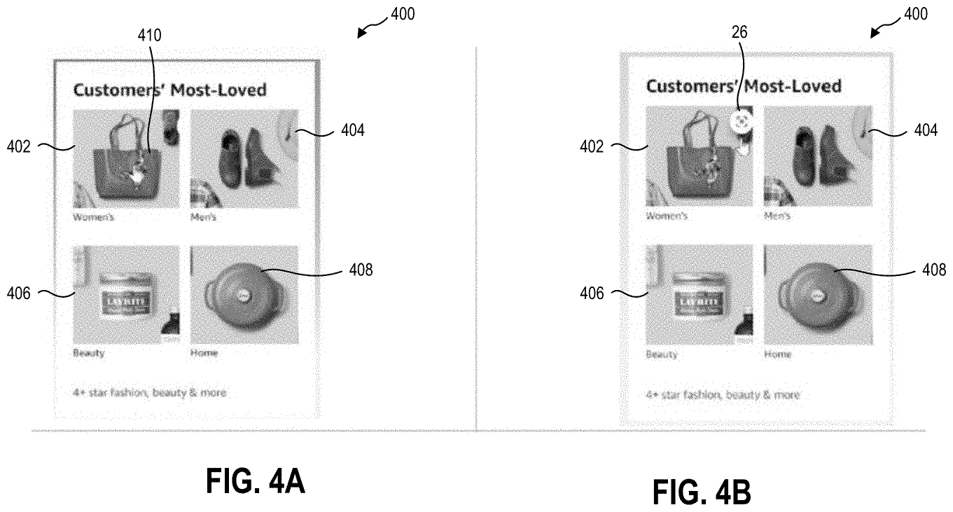

Referring now to FIGS. 4A and 4B, illustrated is an example GUI of a webpage 400 displayed within a browser 10 (FIG. 1). The webpage 400 includes a plurality of images 402, 404, 406, 408 for different products. As shown in FIG. 4A, the user 104 (FIG. 1) may perform a hover over the image 402 by placing the pointer 410 over the image 402 for a period of time (e.g., one second). In FIG. 4B, a visual search icon 26 is displayed on the image 402 in response to the browser 10 detecting the hover over the image 402. The browser 10 may only display the visual search icon 26 on the image 402 where the hover is detected while the remaining images 404, 406, 408 do not include the visual search icon 26. The browser 10 may also position the visual search icon 26 in the top right corner of the image 402 to prevent the visual search icon 26 from covering the purse in the image 402.

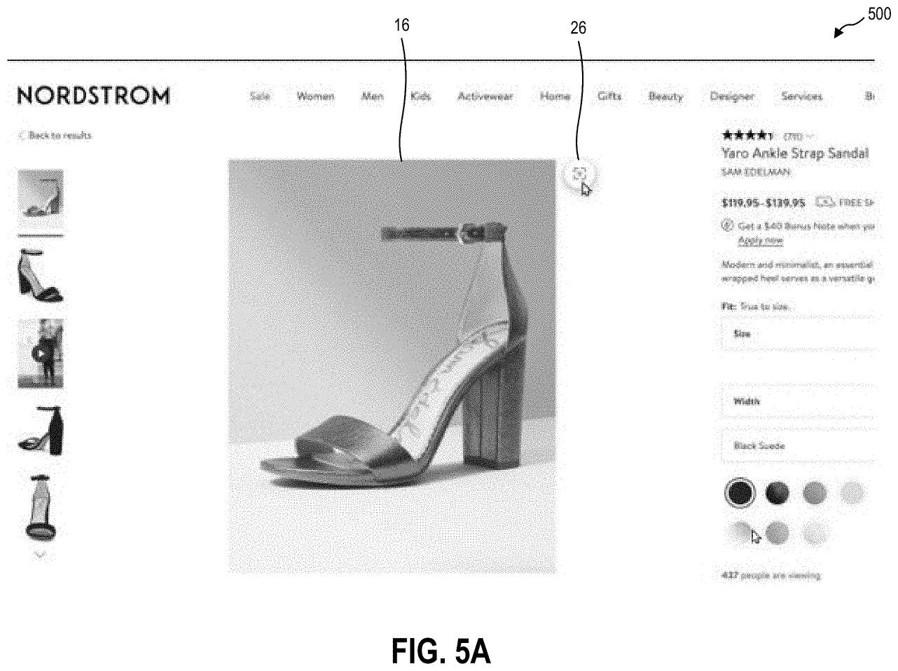

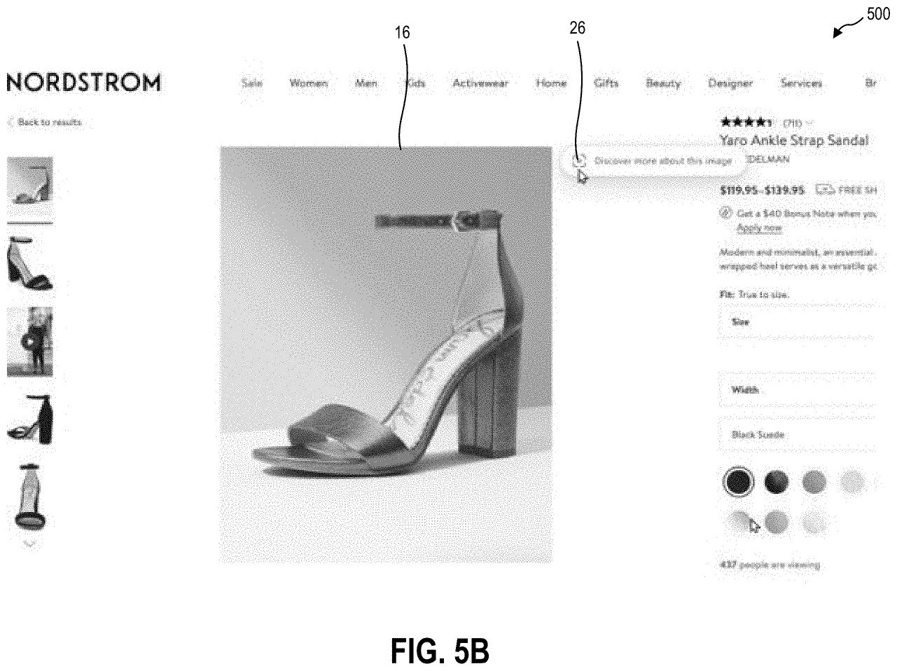

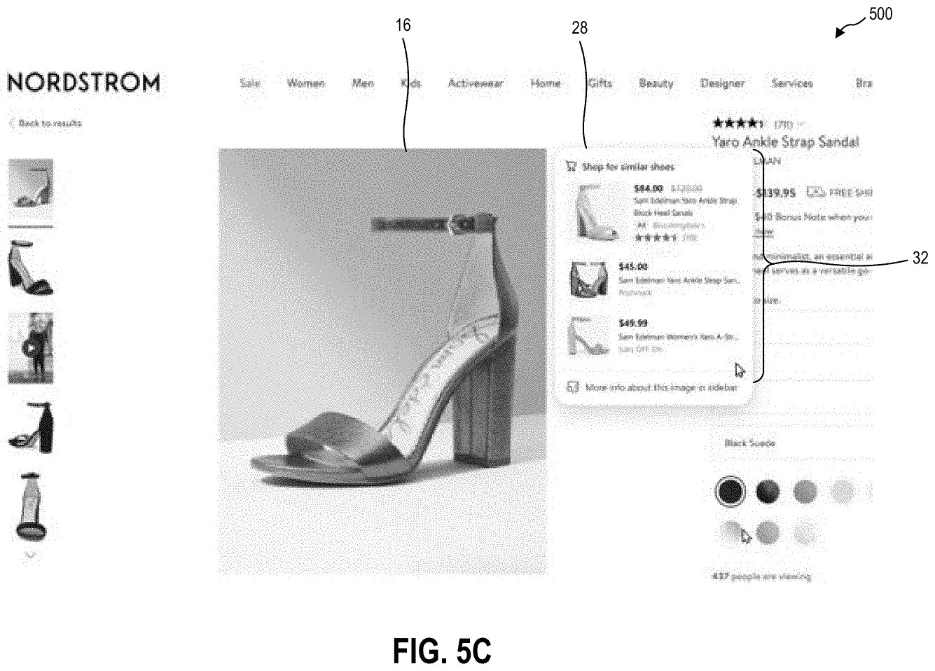

Referring now to FIG. 5A, illustrated is an example GUI of a webpage 500 with a visual search icon 26 presented next to a selected image 16. The visual search icon 26 is presented to the right of the selected image 16 on the webpage 500. FIG. 5B illustrates an expanded visual search icon 26. For example, if the user 104 places a cursor on the visual search icon 26, the visual search icon 26 expands to include the additional text “discover more about this image.” The additional text may notify the user 104 of the possibility of performing a visual search 36 on the selected image 16.

FIG. 5C illustrates a flyout 28 with visual search results 32 presented next to the selected image 16 (e.g., to the right of the selected image 16). The flyout 28 may be presented in an overlay over the remaining content on the webpage 500 (e.g., the user ratings of the shoes presented in the selected image 16) without changing or modifying the remaining content of the webpage 500. As such, the user 104 may keep the original content of the webpage 500 while viewing the visual search results 32 in the flyout 28.

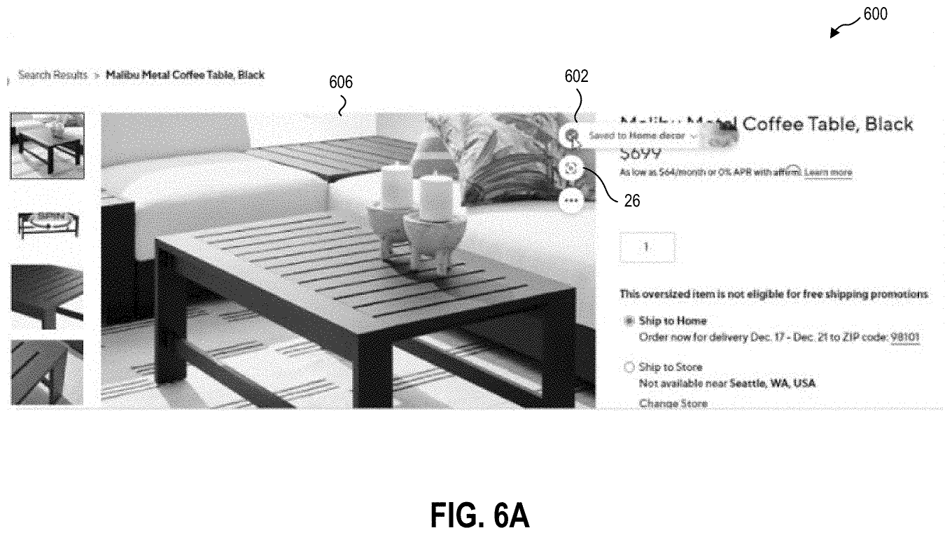

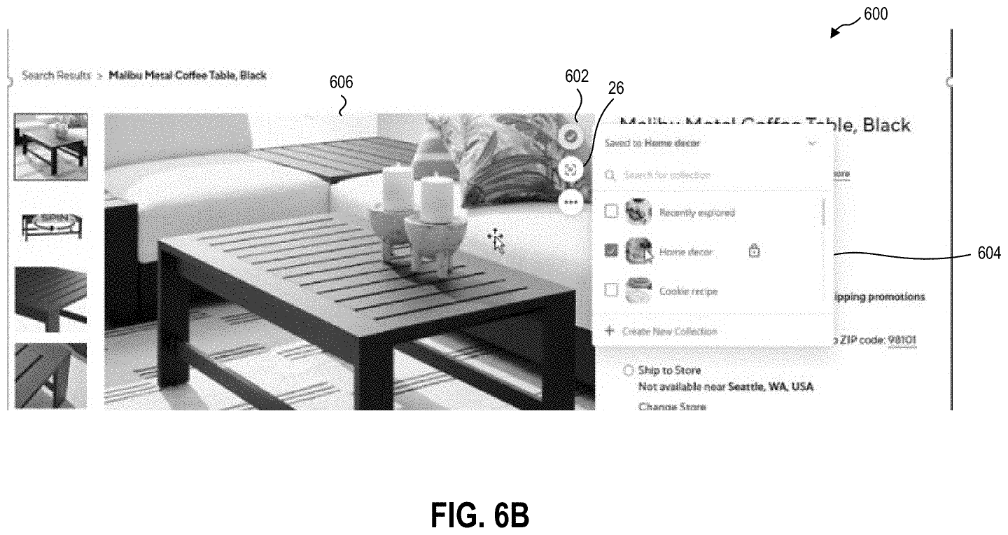

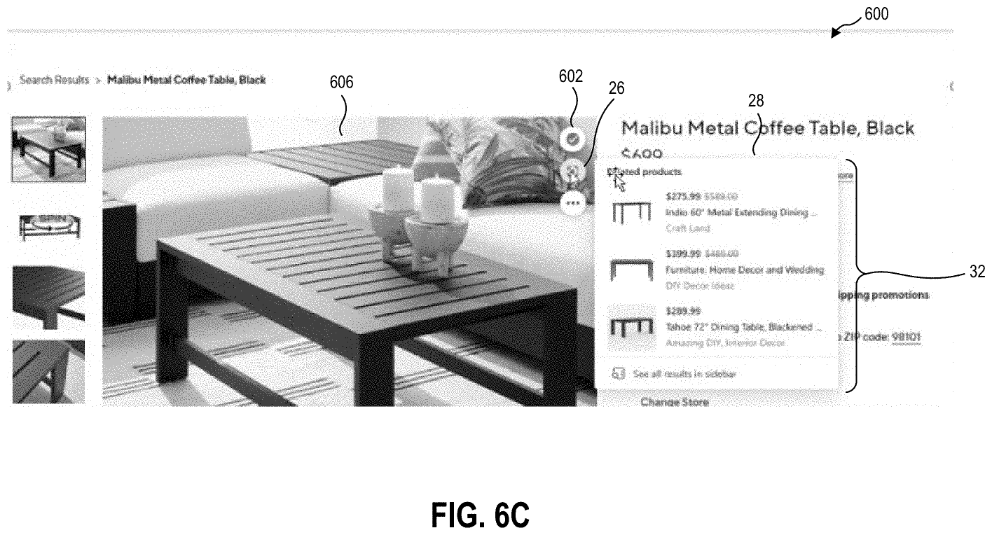

Referring now to FIG. 6A, illustrated is an example GUI of a webpage 600 with an icon 602 presented on an image 606 on the webpage 600. The icon 602 may allow the user 104 to save the image 606 and/or any visual search results 32 of the image 606 to a collection of the user 104. Collections may include, for example, home decor, yard projects, recipes, or travel. The icon 602 may be presented above the visual search icon 26 for the image 606. In an implementation, the icon 602 and the visual search icon 26 may be a combined into a single icon presented on the selected image. FIG. 6B illustrates a popup window 604 displayed on webpage 600 with different collections the user 104 may select for saving the selected image 16. For example, the user 104 selected the “home decor” collection to save the selected image 16 of the coffee table.

FIG. 6C illustrates a flyout 28 with visual search results 32 for the image 606. For example, if the user 104 selects the visual search icon 26 under the icon 602, a visual search request 30 may be sent to the search engine 106 to perform a visual search 36 for the image 606. The flyout 28 presents the received visual search results 32 from the search engine 106. The user 104 may also save the visual search results 32 to the selected collection (e.g., “home decor” collection in FIG. 6B).

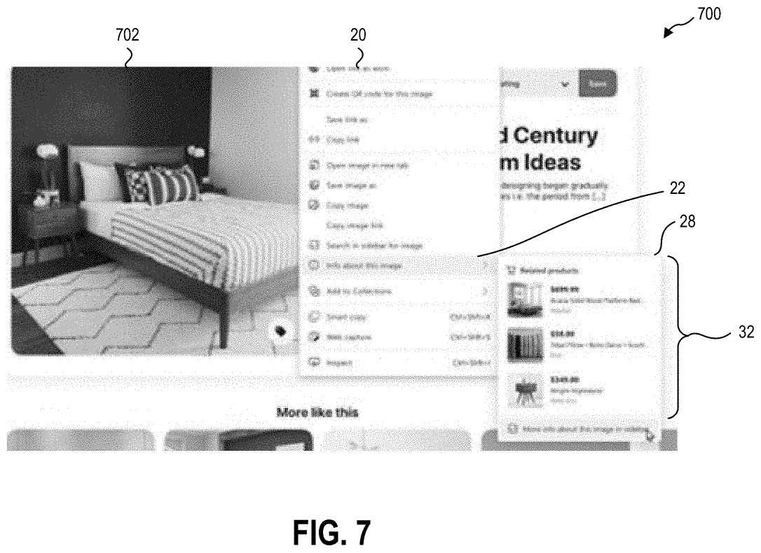

Referring now to FIG. 7, illustrated is an example GUI of a webpage 700 with a context menu 20 displayed next to an image 702. The context menu 20 includes a visual search option 22. The context menu 20 may be presented in response to receiving a right-click on the image 702 by the user 104. The webpage 700 also includes a flyout 28 with the visual search results 32 presented next to the context menu 20. As such, if the user 104 selects the visual search option 22 from the context menu 20, the visual search results 32 may appear on the webpage 700 in a flyout 28 without the user 104 leaving the webpage 700 or having to open a new tab to view the visual search results 32. The context menu 20 and the flyout 28 may be presented in popup windows over the webpage 700.

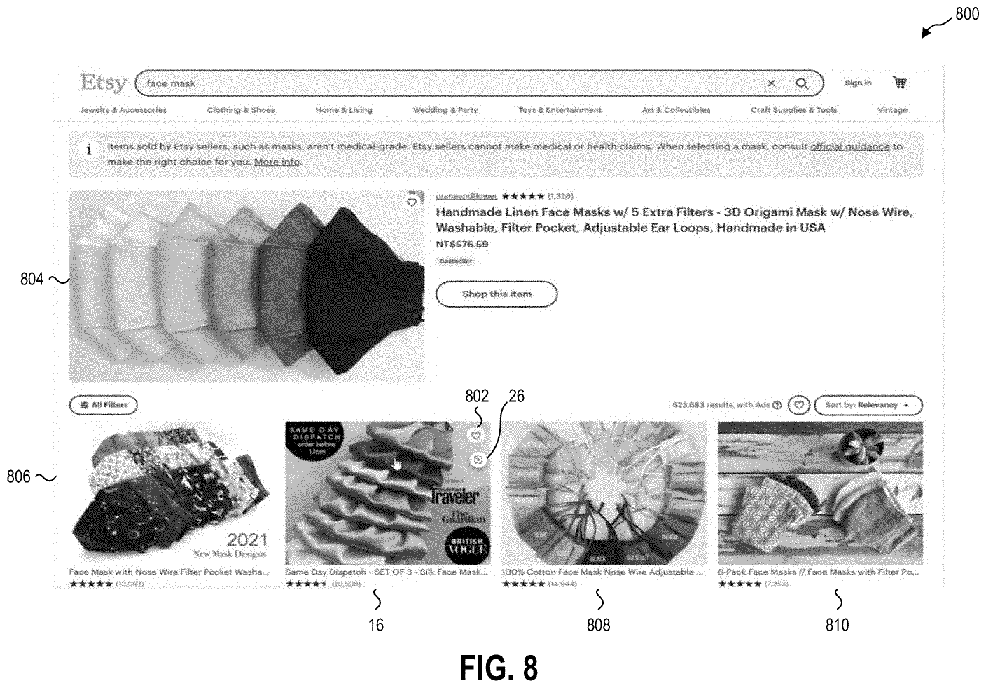

Referring now to FIG. 8, illustrated is an example GUI of a webpage 800 with a plurality of images 16, 804, 806, 808, 810. The selected image 16 include an icon 802 (e.g., a heart) and the browser 10 places the visual search icon 26 below the icon 802 on the selected image 16. Placing the visual search icon 26 below the heart icon 802 may prevent the visual search icon 26 from interfering with the functionality of the webpage 800 (e.g., allowing the user to select the heart icon 802). Moreover, by placing the visual search icon 26 nearby the heart icon 802 the user 104 may be more likely to view the visual search icon 26.

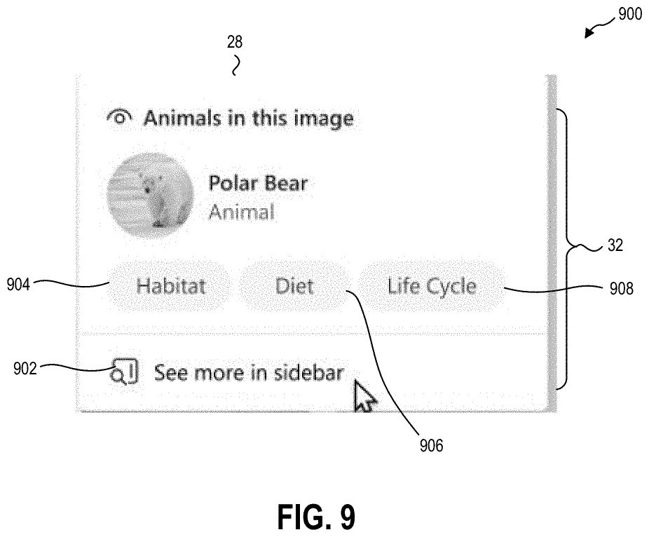

Referring now to FIG. 9, illustrated is an example GUI 900 of a flyout 28 with visual search results 32 for a selected image 16 (FIG. 1). The flyout 28 may include a subset of the visual search results 32. The subset of the visual search results 32 may include the identified animal (polar bear) in the selected image 16 and one or more buttons (habitat 904, diet 906, life cycle 908) that the user 104 may select to learn more about the polar bear. The browser 10 may perform related searches for the different buttons selected. In some implementations, when the user 104 selects one or more buttons (habitat 904, diet 906, life cycle 908), a textual search is performed (e.g., polar bear habitat). The flyout 28 includes an icon 902 that allows the user 104 to view the additional textual search results in the sidebar 34 (FIG. 1). In some implementations, the flyout 28 also includes an icon 902 that allows the user 104 to view additional visual search results 32 in a sidebar 34 (FIG. 1). The user 104 may select the icon 902 to expand the visual search results 32 presented for the selected image 16. The flyout 28 may provide a preview of a subset of the visual search results 32 right next to the selected image 16 and the user 104 may decide to explore the visual search results 32 further by seeing additional visual search results 32 in the sidebar 34. As such, the user 104 may take different actions from the visual search results 32 (e.g., performing additional textual or visual searches to learn more about the identified animal or opening the sidebar 34 to view additional textual or visual search results 32).

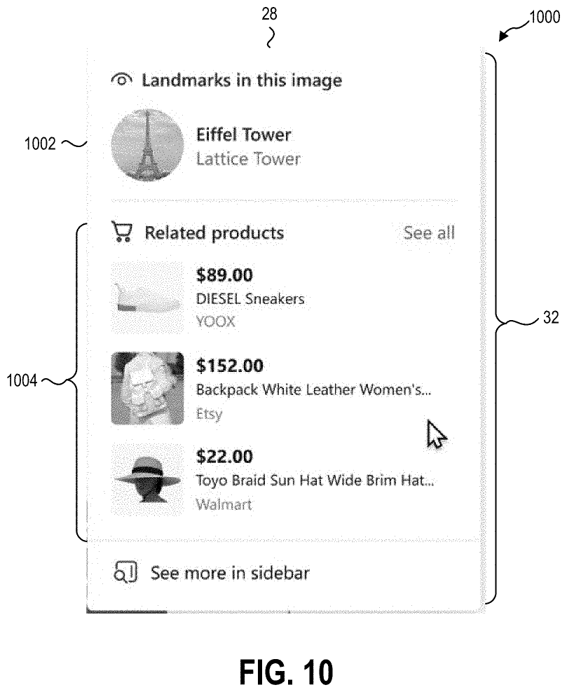

Referring now to FIG. 10, illustrated is an example GUI 1000 of a flyout 28 with visual search results 32 for a landmark identified in the selected image 16 (FIG. 1) and a product identified in the selected image 16. The search engine 106 may identify different items, landmarks, objects, products in the selected image 16 and the search engine 106 may provide visual search results 32 for the different items, landmarks, objects, or products identified in the selected image 16. For example, the original image includes a woman standing nearby the Eiffel Tower wearing different accessories (a hat, a watch, jewelry, a backpack, and sneakers). The flyout 28 presents a set of visual search results 1002 for the Eiffel Tower, the landmark identified in the selected image 16. In addition, the flyout 28 presents a set of visual search results 1004 for the related products of the product identified in the selected image 16 (e.g., different accessories worn by the woman in the selected image 16). As such, both the products and the landmarks are identified in the selected image 16. In some implementations, the user 104 explores both the landmarks and the products in the visual search results 1004. In some implementations, the user 104 selects one option and sees the visual search results 1004 for the selected option (e.g., only views the visual search results 1004 for the landmarks or only views the visual search results 1004 for the products).

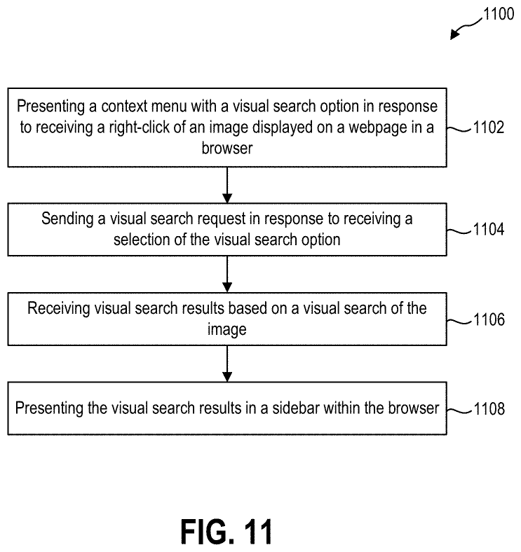

Referring now to FIG. 11, illustrated is an example method 1100 for performing visual searching. The actions of the method 1100 are discussed below with reference to the architecture of FIG. 1.

At 1102, the method 1100 includes presenting a context menu with a visual search option in response to receiving a right-click of an image displayed on a webpage in a browser. The browser 10 presents a context menu 20 with a visual search option 22 in response to the user 104 right-clicking an image (e.g., selected image 16) displayed on a webpage 12 using the browser 10.

At 1104, the method 1100 includes sending a visual search request in response to receiving a selection of the visual search option. The browser 10 sends a visual search request 30 to a search engine 106 in response to the user 104 selecting the visual search option 22 of the context menu 20.

At 1106, the method 1100 includes receiving visual search results based on a visual search of the image. The browser 10 receives visual search results 32 for the visual search 36 performed by the search engine 106 for the image (e.g., the selected image 16).

At 1108, the method 1100 includes presenting the visual search results in a sidebar within the browser. The browser 10 presents the visual search results 32 in a sidebar 34 within the browser 10.

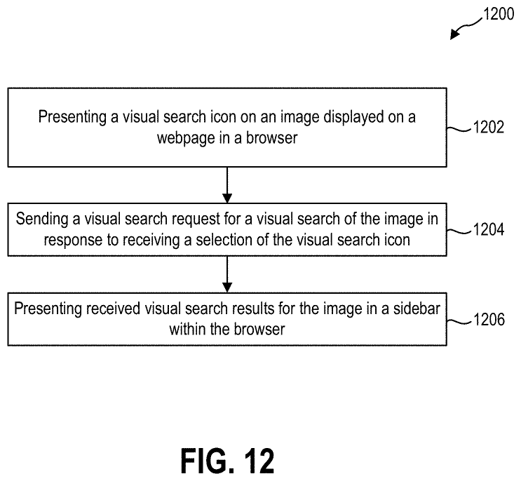

Referring now to FIG. 12, illustrated is an example method 1200 for performing visual searching. The actions of the method 1200 are discussed below with reference to the architecture of FIG. 1.

At 1202, the method 1200 includes presenting a visual search icon on an image displayed on a webpage in a browser. The browser 10 presents a visual search icon 26 on an image (e.g., the selected image 16) displayed on a webpage 12 in the browser 10.

At 1204, the method 1200 includes sending a visual search request for a visual search of the image in response to receiving a selection of the visual search icon. The browser 10 sends a visual search request 30 to a search engine 106 for a visual search 36 of the image (e.g., the selected image 16) in response to the user 104 selecting the visual search icon 26.

At 1206, the method 1200 includes presenting received visual search results for the image in a sidebar within the browser. The browser 10 presents the visual search results 32 received from the search engine 106 in a sidebar 34 within the browser 10.

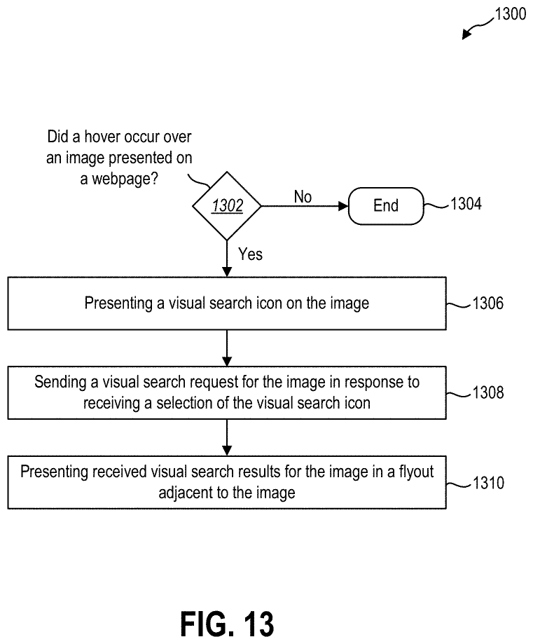

Referring now to FIG. 13, illustrated is an example method 1300 for performing visual searching. The actions of the method 1300 are discussed below with reference to the architecture of FIG. 1.

At 1302, the method 1300 includes determining whether a hover occurred over an image presented on a webpage. The browser 10 may determine whether the user 104 hovered over an image (e.g., the selected image 16) on the webpage 12.

At 1304, the method 1300 ends if the browser 10 did not determine that the user 104 hovered over the image.

At 1306, the method 1300 includes presenting a visual search icon on the image if a hover occurred over the image. The browser 10 presents a visual search icon 26 on the image (e.g., the selected image 16) in response to determining that the user 104 hovered over the image. The browser 10 determines where to place the search icon 26 in relation to the image. In some implementations, the browser 10 places the search icon 26 adjacent to the selected image 16. In some implementations, the browser 10 places the search icon 26 nearby the selected image 16. In some implementations, the browser 10 places the search icon 26 above the selected image 16. In some implementations, the browser 10 places the search icon 26 below the selected image 16. In some implementations, the browser 10 places the search icon 26 near a corner or edge of the selected image 16.

In some implementations, the browser 10 overlays the search icon 26 on the selected image 16. The position of the visual search icon 26 may be selected to prevent occlusion of objects, items, or individuals in the selected image 16 or prevent interference with another icon or click event on the selected image 16. Click events include icons, buttons, or activatable portions in the selected image 16. For example, the browser 10 displays the visual search icon 26 on the edges or corners of the selected image 16. Another example includes the browser 10 displaying the visual search icon 26 near another click event or icon on the selected image 16. For example, if the selected image 16 includes a heart icon (e.g., a click event), the browser 10 may position the visual search icon 26 below the heart icon. In some implementations, the browser 10 automatically determines the position of the visual search icon 26 using hit testing. The hit testing determines whether the visual search icon 26 is receiving click events and/or whether occlusion is occurring for entities in the selected image 16 with the visual search icon 26. If the visual search icon 26 is not receiving click events or if occlusion is occurring for different entities in the selected image 16, the browser 10 may move the visual search icon 26 to a different position.

In some implementations, the browser 10 performs a preliminary entity detection on the selected image 16 to ensure that that the placement of the search icon 26 does not occlude an identified entity (e.g., objects, items, or individuals) in the selected image 16. The preliminary entity detection returns the identified entities in the selected image 16 and the browser 10 uses the information to place the search icon 26 on the selected image 16 to prevent occlusion of faces of individuals and/or other objects of interest.

In some implementations, the browser 10 uses the information from the preliminary entity detection to determine whether to place the search icon 26 on the selected image 16. For example, if the preliminary entity detection indicates that a visual search is not useful (e.g., returns an image of a solid color, a logo, or a web page navigation icon), the browser 16 may not place the search icon 26 on the selected image 16. In some implementations, the browser 10 uses the information from the preliminary entity detection to determine whether to highlight the search icon 26 on the selected image 16. For example, if the preliminary entity detection indicates that a product is detected in the selected image 16, the browser 10 may change the color of the search icon 26 to highlight the search icon 26, or the browser 10 may change the search icon 26 to a shopping bag to highlight the search icon 26. In some implementations, the browser 10 uses the information from the preliminary entity detection to place the search icon 26 on hotspots of the image of individual items detected (e.g., placing the search icon 26 on a purse or a dress).

At 1308, the method 1300 includes sending a visual search request for the image in response to on receiving a selection of the visual search icon. The browser 10 sends a visual search request 30 to a search engine 106 for a visual search 36 of the image (e.g., the selected image 16) in response to the user 104 selecting the visual search icon 26.

At 1310, the method 1300 includes presenting received visual search results for the image in a flyout adjacent to the image. The browser 10 presents the visual search results 32 received from the search engine 106 in a flyout 28 adjacent to the image (e.g., the selected image 16).

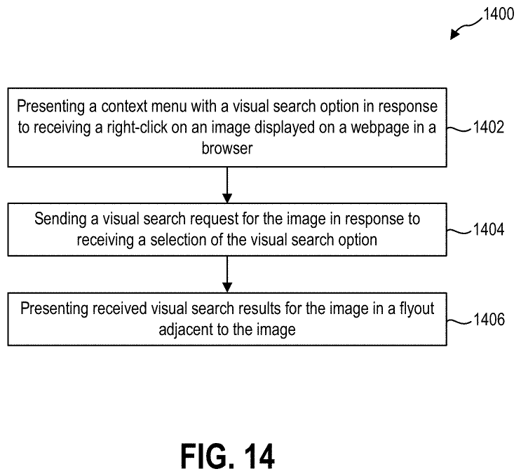

Referring now to FIG. 14, illustrated is an example method 1400 for performing visual searching. The actions of the method 1400 are discussed below with reference to the architecture of FIG. 1.

At 1402, the method 1400 includes presenting a context menu with a visual search option in response to receiving a right-click on an image displayed on a webpage in a browser. The browser 10 presents a context menu 20 with a visual search option 22 in response to the user 104 right-clicking an image (e.g., selected image 16) displayed on a webpage 12 using the browser 10.

At 1404, the method 1400 includes sending a visual search request for the image in response to receiving a selection of the visual search option. The browser 10 sends a visual search request 30 to a search engine 106 in response to the user 104 selecting the visual search option 22 of the context menu 20.

At 1406, the method 1400 includes presenting received visual search results for the image in a flyout adjacent to the image. The browser 10 presents the visual search results 32 received from the search engine 106 in a flyout 28 adjacent to the image (e.g., the selected image 16).

As illustrated in the foregoing discussion, the present disclosure utilizes a variety of terms to describe features and advantages of the model evaluation system. Additional detail is now provided regarding the meaning of such terms. For example, as used herein, a “machine learning model” refers to a computer algorithm or model (e.g., a classification model, a binary model, a regression model, a language model, an object detection model) that can be tuned (e.g., trained) based on training input to approximate unknown functions. For example, a machine learning model may refer to a neural network (e.g., a convolutional neural network (CNN), deep neural network (DNN), recurrent neural network (RNN)), or other machine learning algorithm or architecture that learns and approximates complex functions and generates outputs based on a plurality of inputs provided to the machine learning model. As used herein, a “machine learning system” may refer to one or multiple machine learning models that cooperatively generate one or more outputs based on corresponding inputs. For example, a machine learning system may refer to any system architecture having multiple discrete machine learning components that consider different kinds of information or inputs.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various implementations.

Computer-readable mediums may be any available media that can be accessed by a general purpose or special purpose computer system. Computer-readable mediums that store computer-executable instructions are non-transitory computer-readable storage media (devices). Computer-readable mediums that carry computer-executable instructions are transmission media. Thus, by way of example, and not limitation, implementations of the disclosure can comprise at least two distinctly different kinds of computer-readable mediums: non-transitory computer-readable storage media (devices) and transmission media.

As used herein, non-transitory computer-readable storage mediums (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database, a datastore, or another data structure), ascertaining and the like. Also, “determining” can include receiving (e.g., receiving information), accessing (e.g., accessing data in a memory) and the like. Also, “determining” can include resolving, selecting, choosing, establishing, predicting, inferring, and the like.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional implementations that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to implementations disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the implementations that falls within the meaning and scope of the claims is to be embraced by the claims.

### INDUSTRIAL APPLICABILITY

The present disclosure is related to methods and systems for performing visual searching. The methods and systems allow users to trigger a visual search within the user's browsing context. The methods and systems allow users to discover related content for any images or videos in a browser search result page by requesting a visual search for the images or videos. In an implementation, the visual search results show on any webpage accessed through the browser through a flyout or popup window displayed on the webpage. In another implementation, the visual search results display in a sidebar presented nearby, or adjacent to, any webpage accessed through the browser.

A trigger for visual searches includes an on-hover on an image (e.g., the user hovers over an image). Images viewed in the browser have a visual search icon overlaid on the image in response to detecting a hover by the user over the image. Selecting the visual search icon by the users sends a visual search request for the image to a search engine to perform the visual search and causes a sidebar to open with visual search results or a flyout to display with visual search results.

Another trigger for visual searches includes the context menu of the browser (e.g., the context menu includes a visual search option). Selecting the visual search option in the context menu by the users sends a visual search request for the image to a search engine to perform the visual search and cause a sidebar to open with visual search results or a flyout to display with visual search results.

One technical advantage of the methods and systems is allowing users to seamlessly discover visual search results while remaining in-context of the browser. Remaining in-context of the browser saves users from needing to save the images to the device and upload the saved images to the browser for the visual search. As such, users may perform quick searches of the images while staying in-context of the browser, and thus, the methods and systems encourage visual searches without disrupting the core experience of the users browsing. Another technical advantage of the methods and systems is increased browser search functionality by leveraging browser distribution alongside visual search.

The methods and systems provide a convenient visual search experience to allow visual searching without disrupting the browsing task at hand, and thus, increasing user engagement with the browser by incorporating visual search into the browser context.

(A1) Some implementations include a method for performing visual searching. The method includes presenting a webpage (e.g., webpage 12) including an image (e.g., selected image 16). The method includes presenting (1102) a context menu (e.g., context menu 20) with a visual search option (e.g., visual search option 22) in response to receiving a user selection of the image (e.g., selected image 16). The method includes sending (1104) a visual search request (e.g., visual search request 30)for the image in response to receiving a selection of the visual search option. The method includes receiving (1106) visual search results (e.g., visual search results 32) based on a visual search (e.g., visual search 36) of the image. The method includes while continuing to present the webpage, presenting (1108) the visual search results in a sidebar (e.g., sidebar 34) within the browser.

(A2) In some implementations of the method of A1, presenting the visual search results occurs in a sidebar within the browser.

(A3) In some implementations of the method of A1 or A2, the sidebar is adjacent to the webpage.

(A4) In some implementations of the method of any of A1-A3, the sidebar is in a right pane of the browser.

(A5) In some implementations of the method of any of A1-A4, the sidebar is a separate window from the webpage.

(A6) In some implementations of the method of any of A1-A5, a size of the sidebar is based on a pixel value or a percentage of a display size.

(A7) In some implementations of the method of any of A1-A6, presenting the visual search results occurs in a flyout adjacent to the image.

(A8) In some implementations of the method of any of A1-A7, the flyout is displayed in an overlay of the webpage and is visually distinct from the webpage.

(A9) In some implementations of the method of any of A1-A8, the flyout is displayed based on one or more of an available screen space or a position of the image on the webpage.

(A10) In some implementations of the method of any of A1-A9, the flyout closes automatically when a user moves a pointer or mouse cursor to a different location on the webpage.

(A11) In some implementations of the method of any of A1-A10, the visual search results include one or more of similar images, related images, product images, or related searches based on the image.

(B1) Some implementations include a method for performing visual searching. The method includes presenting a webpage (e.g., webpage 12) including an image (e.g., selected image 16). The method includes presenting (1202) a visual search icon (e.g., visual search icon 26) on the image (e.g., selected image 16). The method includes sending (1204) a visual search request (e.g., visual search request 30) for a visual search (e.g., visual search 36) of the image in response to receiving a selection of the visual search icon. The method includes while continuing to present the webpage, presenting (1206) received visual search results (e.g., visual search results 32) for the image in a sidebar (e.g., sidebar 34) within the browser.

(B2) In some implementations, the method of B1 includes detecting a hover over the image; and presenting the visual search icon on the image in response to detecting the hover.

(B3) In some implementations of the method of B1 or B2, the hover occurs after a user positions a pointer or a mouse cursor over the image for a time period.

(B4) In some implementations, the method of any of B1-B3 includes comparing an image size of the image to a threshold; if the image size is equal to or greater than a threshold, presenting the visual search icon; and if the image size is less than the threshold, foregoing presenting the visual search icon.

(B5) In some implementations of the method of any of B1-B4, the threshold is a minimum image size.

(B6) In some implementations of the method of any of B1-B5, the threshold is a ratio of the image size to a size of the visual search icon.

(B7) In some implementations of the method of any of B1-B6, the visual search icon is presented in a corner or an edge of the image.

(B8) In some implementations, the method of any of B1-B7 includes determining a position on the image for the visual search icon; and presenting the visual search icon at the position.

(B9) In some implementations, the method of any of B1-B8 includes if the position of the visual search icon is causing occlusion to the image, selecting a different position on the image for the visual search icon; and if occlusion to the image is not occurring by the position of the visual search icon, presenting the visual search icon at the position.

(B10) In some implementations, the method of any of B1-B9 includes if the position of the visual search icon is covering up another click event on the image, selecting a different position on the image for the visual search icon.

(B11) In some implementations of the method of any of B1-B10, the webpage presents a plurality of images.

(B12) In some implementations, the method of any of B1-B11 includes identifying one or more dominant images of the plurality of images; and presenting the visual search icon on the image based on determining that the image is a dominant image.

(B13) In some implementations of the method of any of B1-B12, the one or more dominant images are relevant to content of the webpage.

(B14) In some implementations of the method of any of B1-B13, identifying the one or more dominant images is based on a source of the one or more dominant images.

(B15) In some implementations of the method of any of B1-B14, presenting the visual search results occurs in a sidebar adjacent to the webpage within the browser.

(B16) In some implementations of the method of any of B1-B15, the sidebar is adjacent to the webpage.

(B17) In some implementations of the method of any of B1-B16, the sidebar is in a right pane of the browser.

(B18) In some implementations of the method of any of B1-B17, presenting the visual search results occurs in a flyout adjacent to the image.

(C1) Some implementations include a method for performing visual searching. The method includes detecting (1302) a hover over an image (e.g., selected image 16) presented on a webpage (e.g., webpage 12) in a browser (e.g., browser 10). The method includes presenting (1306), in response to the hover, a visual search icon (e.g., visual search icon 26) on the image. The method includes sending (1308) a visual search request (e.g., visual search request 30) for the image in response to receiving a selection of the visual search icon. The method includes presenting (1310) received visual search results (e.g., visual search results 32) for the image in a flyout (e.g., flyout 28) adjacent to the image.

(C2) In some implementations of the method of C1, the flyout is displayed in an overlay of the webpage.

(C3) In some implementations of the method of C1 or C2, the flyout is a popup window on the webpage.

(C4) In some implementations of the method of any of C1-C3, the flyout is displayed based on available screen space.

(C5) In some implementations of the method of any of C1-C4, the flyout is visually distinct from the webpage.

(C6) In some implementations of the method of any of C1-C5, the flyout is displayed based on a position of the image on the webpage.

(C7) In some implementations of the method of any of C1-C6, if the image is positioned lower on the webpage, the flyout is displayed higher on the webpage, and if the image is positioned higher on the webpage, the flyout is displayed lower on the webpage.

(C8) In some implementations of the method of any of C1-C7, the flyout closes automatically when a user moves to a different location on the webpage.

(C9) In some implementations, the method of any of C1-C8 includes presenting the visual search results in a sidebar within the browser, wherein sidebar is adjacent to the webpage.

(C10) In some implementations of the method of any of C1-C9, the hover occurs after a user positions a pointer or a mouse cursor over the image for a time period.

(C11) In some implementations of the method of any of C1-C10, the visual search results include one or more of similar images, related images, product images, or related searches based on the image.

(D1) Some implementations include a method for performing visual searching. The method includes presenting (1402) a context menu (e.g., context menu 20) with a visual search option (e.g., visual search option 22) in response to receiving a right-click on an image (e.g., selected image 16) displayed on a webpage (e.g., webpage 12) in a browser (e.g., browser 10). The method includes sending (1404) a visual search request (e.g., visual search request 30) for the image in response to receiving a selection of the visual search option. The method includes presenting (1406) received visual search results (e.g., visual search results 32) for the image in a flyout (e.g., flyout 28) adjacent to the image.

(D2) In some implementations of the method of D1, the flyout is displayed in an overlay of the webpage.

(D3) In some implementations of the method of D1 or D2, the flyout is displayed based on available screen space.

(D4) In some implementations of the method of any of D1-D3, the flyout is visually distinct from the webpage.

(D5) In some implementations of the method of any of D1-D4, the flyout is displayed based on a position of the image on the webpage.

(D6) In some implementations of the method of any of D1-D5, the flyout closes automatically when a user moves a pointer or mouse cursor to a different location on the webpage.

(D7) In some implementations, the method of any of D1-D6 includes presenting the visual search results in a sidebar within the browser, wherein sidebar is adjacent to the webpage.

Some implementations include a system (environment 100). The system includes one or more processors; memory in electronic communication with the one or more processors; and instructions stored in the memory, the instructions being executable by the one or more processors to perform any of the methods described here (e.g., A1-A11, B1-B18, C1-C11, D1-D7).

Some implementations include a computer-readable storage medium storing instructions executable by one or more processors to perform any of the methods described here (e.g., A1-A11, B1-B18, C1-C11, D1-D7).

Some implementations include a browser (e.g., browser 10) executable by one or more processors to perform any of the methods described herein (e.g., A1-A11, B1-B18, C1-C11, D1-D7).

The present disclosure may be embodied in other specific forms without departing from its spirit or characteristics. The described implementations are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for performing visual searching, comprising:
presenting a webpage including an image;
presenting a context menu with a visual search option in response to receiving a user selection of the image;
sending a visual search request for the image in response to receiving a user selection of the visual search option;
receiving visual search results based on a visual search of the image; and
while continuing to present the webpage, presenting the visual search results.

2. The method of claim 1, wherein presenting the visual search results occurs in a sidebar within the browser.

3. The method of claim 2, wherein the sidebar is adjacent to the webpage, the sidebar is in a right pane of the browser, or the sidebar is a separate window from the webpage.

4. The method of claim 2, wherein a size of the sidebar is based on a pixel value or a percentage of a display size.

5. The method of claim 1, wherein presenting the visual search results occurs in a flyout adjacent to the image.

6. The method of claim 5, wherein the flyout is displayed in an overlay of the webpage and is visually distinct from the webpage.

7. The method of claim 5, wherein the flyout is displayed based on one or more of an available screen space or a position of the image on the webpage.

8. The method of claim 5, wherein the flyout closes automatically when a user moves a pointer or mouse cursor to a different location on the webpage.

9. The method of claim 1, wherein the visual search results include one or more of similar images, related images, product images, or related searches based on the image.

10. A method for performing visual searching, comprising:
presenting a webpage including an image;
presenting a visual search icon on the image;
sending a visual search request for a visual search of the image in response to receiving a selection of the visual search icon; and
while continuing to present the webpage, presenting received visual search results for the image.

11. The method of claim 10, further comprising:
detecting a hover over the image, wherein the hover occurs after a user positions a pointer or a mouse cursor over the image for a time period; and
presenting the visual search icon on the image in response to detecting the hover.

12. The method of claim 10, further comprising:
comparing an image size of the image to a threshold;
if the image size is equal to or greater than a threshold, presenting the visual search icon; and
if the image size is less than the threshold, foregoing presenting the visual search icon.

13. The method of claim 12, wherein the threshold is one or more of a minimum image size or a ratio of the image size to a size of the visual search icon.

14. The method of claim 10, wherein the visual search icon is presented in a corner or an edge of the image.

15. The method of claim 10, further comprising:
determining a position on the image for the visual search icon based on a preliminary entity detection on the image; and
presenting the visual search icon at the position.

16. The method of claim 15, further comprising:
if the position of the visual search icon is causing occlusion to identified entities in the image, selecting a different position on the image for the visual search icon;
if occlusion to the identified entities in the image is not occurring by the position of the visual search icon, presenting the visual search icon at the position; and
if the position of the visual search icon is covering up the identified entities in the image, selecting a different position on the image for the visual search icon.

17. The method of claim 15, wherein the webpage presents a plurality of images, and the method further comprises:
identifying one or more dominant images of the plurality of images, wherein the one or more dominant images are relevant to content of the webpage; and
presenting the visual search icon on the image based on determining that the image is a dominant image.

18. The method of claim 10, wherein presenting the visual search results occurs in a sidebar adjacent to the webpage within the browser.

19. The method of claim 10, wherein presenting the visual search results occurs in a flyout adjacent to the image.

20. The method of claim 20, wherein the visual search results include one or more of similar images, related images, product images, or related searches based on the image.
